(19) United States
(12) Patent Application Publication
(10) Pub. No.: US 2002/0131633 A1
(43) Pub. Date: Sep. 19, 2002

(54) System and method for machine vision inspection through platen

(76) Inventors: Robert Leonard Zwick, Madison, NJ (US); James Evan Blumenfeld, Lincroft, NJ (US); Gregory Joseph Klaus, Piscataway, NJ (US)

Correspondence Address: DARBY & DARBY P.C., 805 Third Avenue, New York, NY, 10022, US

(21) Appl. No.: 09/923,028

(22) Filed: Aug. 6, 2001

Related U.S. Application Data
(60) Provisional application No. 60/275,371, filed on Mar. 13, 2001.

(51) Int. Cl. G06K 9/00

(52) U.S. Cl. 382/152

(57) ABSTRACT

A method and system are provided for quickly locating dissimilar parts within the same viewing plane (or range) of a machine vision system, which automatically eliminates variation in distance between the viewed part and the viewing camera. This system eliminates the need to either recalibrate the software used in gauging, or to reposition the camera in order to duplicate a distance standard. A system and user interface are also described to properly locate dissimilar parts to be inspected, or gauged, on the viewing plane.

This application claims the benefit of priority under 35 U.S.C. § 119(e) from U.S. Provisional Application No. 60/275,371, filed Mar. 13, 2001, entitled “System And Method For Machine Vision Inspection Through Platen.

### BACKGROUND OF THE INVENTION

One application for machine vision systems is to inspect and gauge objects during a manufacturing cycle. FIG. 1 illustrates conventional vision machinery 100 which combines image capture equipment such as a CCD camera 110 with hardware 120 and software 130. These components cooperate to provide an operator with information concerning the image of a given sample 140 located within a field of view 150 of the camera. By way of example, the vision machinery 100 can be the In-Sight 2000™ vision sensor made available from Cognex Corporation of Natick, Mass. Typically, such systems are utilized in assembly lines in which an image of similar samples 140 is captured by the camera 110 as it moves along a conveyor, measurements are derived based on an analysis of the image data relative to a standard product definition maintained in the software 130, and the sample is gauged on that standard to determine whether the part has been manufactured correctly (e.g., in accordance with prescribed tolerances).

Digital cameras, and the machine vision systems that use them, impart a finite resolution to the digital images they produce. By way of illustration, the camera 110 can produce digital images 45, 50 that are 1000 pixels across by 800 pixels high. The pixel density of the camera/lens combination defines an area referred to herein as the “field of view.” A sample 40 captured as an image by such a system will occupy a discrete number of pixels within that full scale field of view. One can then count the pixels within the digital image according to a standard product definition contained within the software 130. The accompanying relationship between the pixels will yield specific gauging information such as, but not limited to, length, width, radii, angles, arcs, etc.

FIGS. 1A and 1B illustrate the principle of how a sample 40 can be imaged and gauged, if it has been correctly oriented within the field of view 150 of a digital camera 110. For example, as shown in FIG. 1B, if sample 40 were captured within a digital image 45 at distance “A,” the resulting sample image 41 would occupy a specific portion of the digital image 45. A measure of the width 60 of one side would yield, for the purpose of this discussion, 143 pixels. The radius 61 of the hole would yield 71 pixels. Assuming the machine vision system hardware 120 and software 130 were calibrated to covert these pixel measurements at distance “A” to precisely the same measurements as the actual sample 40, then the machine vision system would properly gauge any measurement of that sample, when located at this same distance and suitably oriented. However, if the same sample 40 were captured within a digital image 50 at distance “B” as shown in FIG. 1C, the resulting sample image 51 would occupy a greater portion of the digital image 50. A measure of the width 70 of one side would yield, for the purpose of this illustration, 214 pixels. The radius 71 of the hole would then yield 95 pixels. Assuming, however, that the machine vision hardware 120 and software 130 were not recalibrated to the correct distance “B,” then any gauging of sample 40 would give different results than those measured at distance “A.” Consequently, machine vision gauging systems have traditionally necessitated the inspection of uniformly oriented and similar parts, where the distance to the camera is known and fixed.

With reference again to FIG. 1, the position of the camera 110 relative to the leading edge of the sample 140 (see distance D1) as well as the selection of lens 112 must be established to ensure that the sample fits within the field of view 150, is in focus, and is properly oriented. If the sample 140 is judged as being out of specification by the software 130, a servo-operated pusher 160 or the like can remove the part from the assembly line in response to a trigger signal provided by the software.

Complications arise, however, when more than one type of sample needs to be inspected. A sample 170 that differs in size (which size difference results in a change to the distance to the camera in FIG. 1) from sample 140 will occupy a different position relative to the camera 110 (see distance D2), and so may not be in focus, may not fit within the field of view, and will occupy a different area of the digital image. This will result in the sample being gauged incorrectly. Only by adjusting the camera position, the lens selection/settings, the calibration of the software, or a combination of these adjustments can samples of different size be correctly processed.

Also, for each sample that is to be inspected, the sample must be oriented within the field of view and positioned such that the captured image can be processed properly (e.g. gauged). That can require a particular orientation and placement for a given sample that, if not followed, can result in data error and reduced manufacturing throughput.

What remains needed in the art is a system and method that permits ready inspection and gauging of a variety of different samples. What is further needed is such a system and method under software control that guides an operator to properly position different types of samples for good data capture and quality analysis. The present invention satisfies these and other needs.

### SUMMARY OF THE INVENTION

In accordance with one aspect of the present invention, a method for inspecting a sample from among a plurality of different workpieces is described. The method operates in a machine vision system of the type including a camera that captures image data of the sample, and includes the steps of: positioning the camera at a prescribed distance from a first side of a generally transparent platen, placing a sample on a second side of the platen, capturing image data of the sample through the platen, and outputting information relating to dimensional characteristics of the sample.

In one preferred implementation of the invention, the captured image data is processed using the product definition corresponding to the sample. In a further preferred implementation of the invention, the method includes the additional step of indicating a position of either the sample or a feature of the sample relative to the platen to assist the operator in inspecting a number of samples of a variety of different workpieces. The method can be operated in a stand-alone machine vision system or in conjunction with other machines connected to the machine vision system through a network.

In accordance with another aspect of the present invention, a method for characterizing one of a plurality of workpieces being inspected by a machine vision system is described. That method includes the steps of: selecting a product definition of one of the plurality of workpieces, placing a sample on a platen within the field of view of the machine vision system, capturing image data of the sample, processing the image data for comparison to the product definition, comparing the processed image data for conformance to the product definition, comparing the processed image data for conformance to historical data concerning prior samples; and reporting to the user information concerning the results of the comparing steps.

In accordance with a further aspect of the present invention, a user interface for interacting with a machine vision system having a computer, an input device, and a display is described. The interface includes a first form for identifying a sample to be inspected, a second form for selecting a product definition for use in measuring the sample; and a button operatively configured to trigger an indicator that indicates a position and an orientation of the sample on the platen in accordance with the selected product definition.

In one preferred implementation of the user interface, an output form is provided and configured to display the measurement of the sample. The output form preferably displays one or more data points, each data point comprising a measured value and a time taken for a particular feature of the sample. Data points for a number of features of the sample can be displayed together on the output form. Also, the output form can display whether criteria in the product definition were met, or whether there was an error in the measurement. Data points for successive measurements can be displayed on a graph. Optionally, the first and second forms are presented together on a single display.

These and further features, aspects, and methodologies can be appreciated from the following description of the Drawing Figures and the Preferred Embodiment.

### DESCRIPTION OF THE DRAWING FIGURES

FIG. 1 illustrates a prior art machine vision system.

FIG. 1A illustrates a constraint on prior art machine vision systems.

FIG. 1B illustrates an image of an object taken at a first distance from the camera/lens combination.

FIG. 1C illustrates an image of the object of FIG. 1B taken at a distance less than the first distance.

FIG. 2 illustrates a machine vision system arranged in accordance with a preferred embodiment of the invention.

FIG. 3 illustrates a method for inspecting samples in accordance with the invention.

FIG. 4 is a part entry form of an exemplary user interface to the machine vision system of FIG. 2 for identifying a part to be processed by the vision machinery.

FIG. 5 is an input form of the exemplary user interface for uploading product definitions to the vision machinery.

FIG. 6 is a job execution form of the exemplary user interface for inspecting a sample against the product definitions loaded in the vision machinery.

FIG. 7 is an information form of the exemplary user interface for displaying information to the user concerning one of the product definitions loaded in the vision machinery.

FIG. 8 is an output form of the exemplary user interface for displaying measurement data (“MD”) concerning a number of features together with thumbnail images of the MD.

FIG. 9 is an enlarged view of the MD, showing sample-to-sample data points to advise users of manufacturing variations and trends.

FIG. 10 illustrates a management form of the exemplary user interface for downloading product definitions from the vision machinery and for writing and editing product definitions and information for the information form of FIG. 7.

### DETAILED DESCRIPTION OF A PREFERRED EMBODIMENT

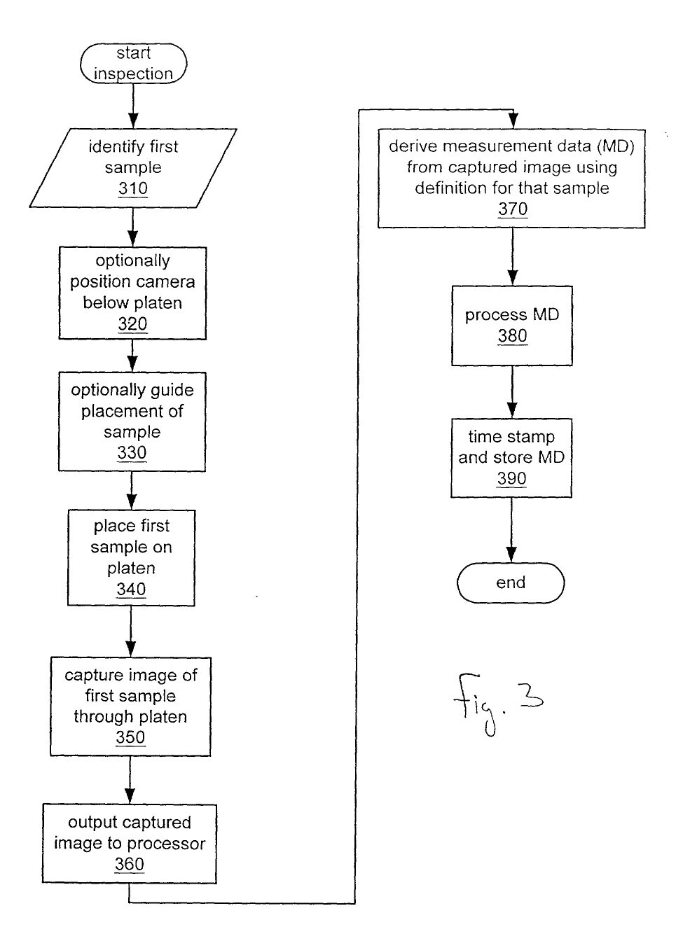

By way of overview and introduction, FIG. 2 illustrates a machine vision system 200 configured in accordance with a preferred embodiment of the invention. The system 200 includes a camera 110, hardware 120 and software 130, as in conventional machine vision systems such as the In-Sight 2000™ vision sensor made by Cognex Corporation. However, the system 200 improves upon conventional vision systems by locating the camera 110 below an optically transparent platen 210 so that wide variations in sample dimension along the direction of the axis Z of the lens 112 can be accommodated without the need for camera or lens adjustment. Consequently, a great variety of samples can be inspected using the system 200 free of any changes in camera lens or position so long as the edge of the sample can rest on the surface 212 of the platen 210 and be contained within the field of view 150. (Larger samples may require that the camera be repositioned to increase the field of view, and that repositioning can be automated in accordance with further features of the preferred embodiment.)

In the following description, the sample dimension in the direction of the Z-axis is referred to as its “thickness” or “height.” It should be understood, however, that the inventive system and method accommodates a great variety of sample “widths” and “depths” too when oriented appropriately on the platen. Also, the extent of the field of view 150 at its intersection with the surface 212 defines the minimum image zone 250 within which a sample must fit to be processed without moving the camera 110. Preferably, the platen 210 is oriented perpendicular to the Z-axis.

Also, as used herein, “field of view” is the area viewed by a camera/lens combination; “spherical aberration” refers to inconsistent bending of light as it is converged through a lens; “distance” refers to the distance from a camera image collector to the viewed plane of an object or sample; “orientation” refers to the rotational orientation of a viewed object within a camera's field of view; “location” refers to the position of a sample or a feature of the sample on the platen (e.g., relative to the Z-axis); “placement” or “placing” of an object includes both orientation and location; and “image” refers to a digital two-dimensional representation of a three-dimensional object.

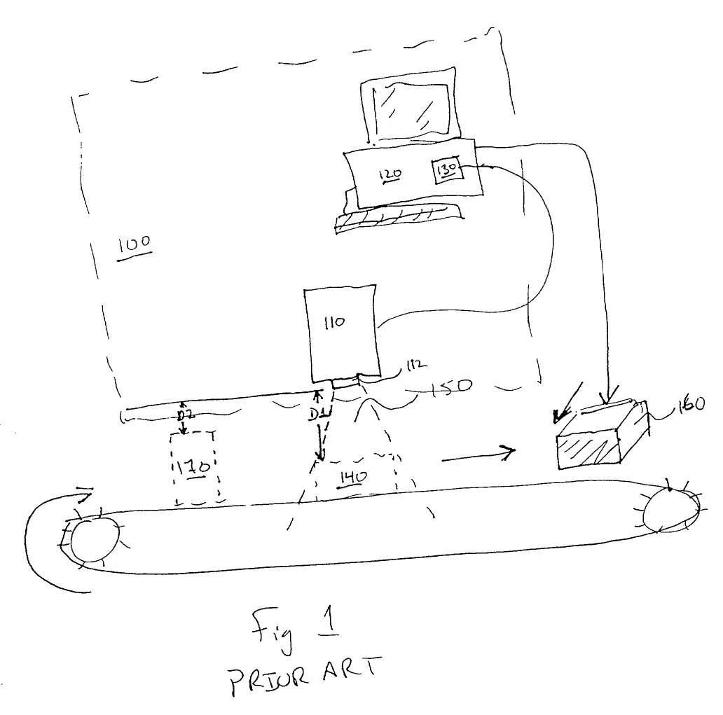

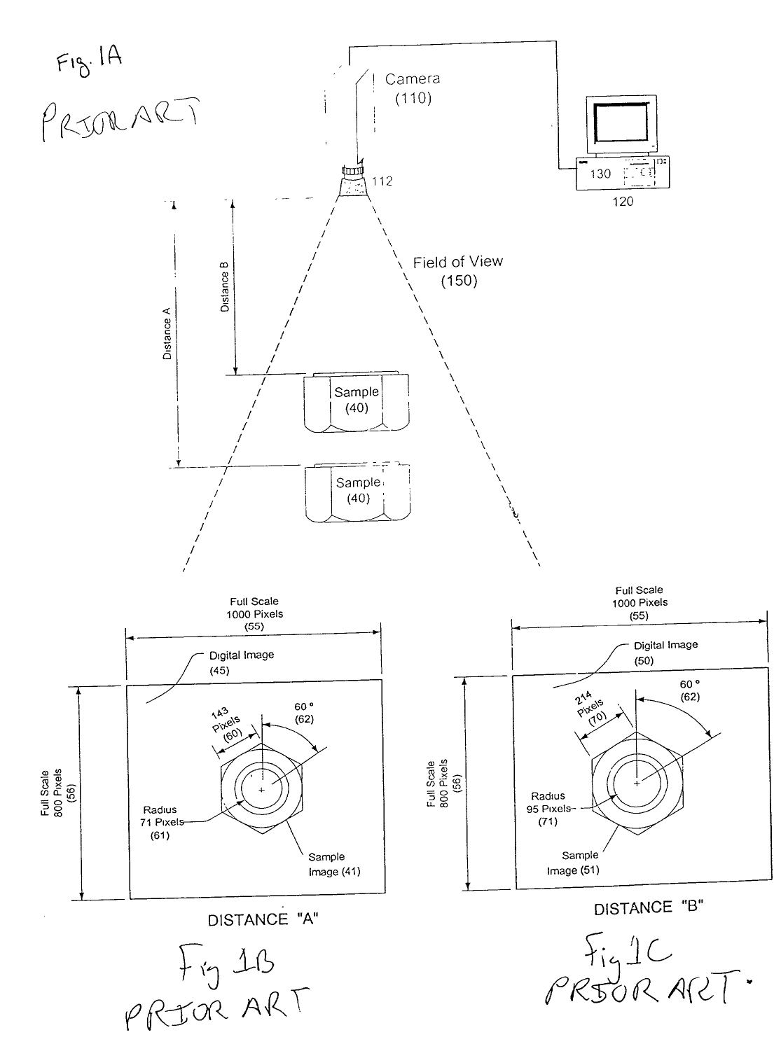

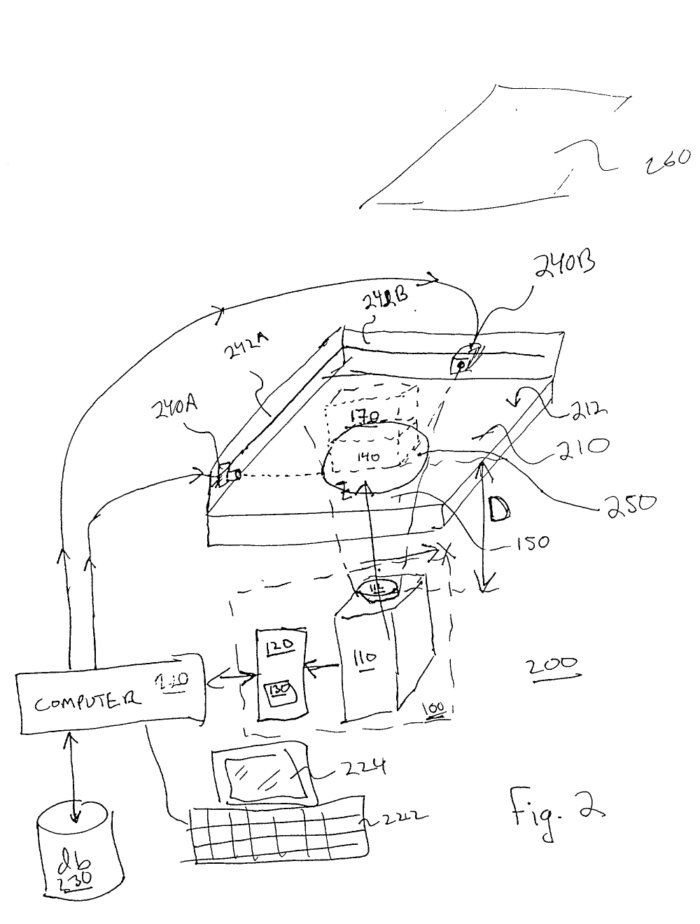

In FIG. 2, the camera lens 112 is at a predetermined distance D from the surface 212. As a result, samples 140 and 170 of FIG. 1 can be inspected without repositioning the camera 110 despite the difference in their respective thickness.

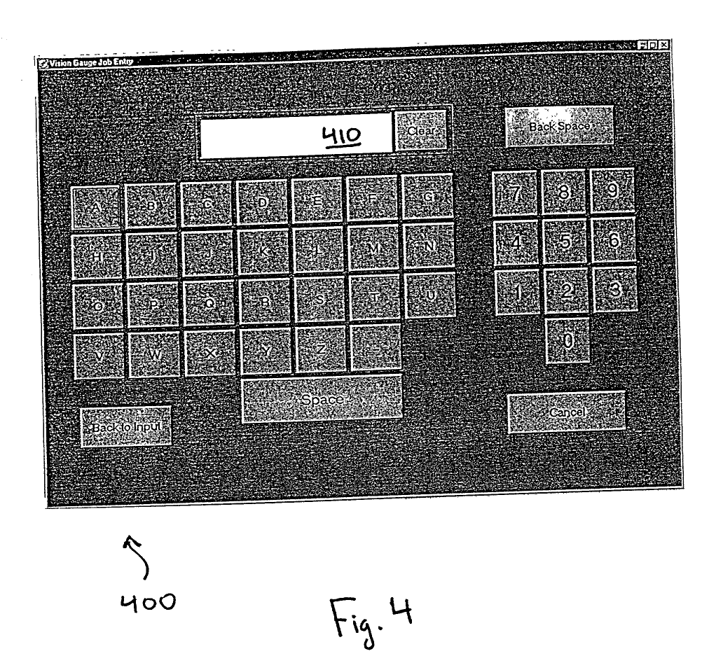

A method for inspecting samples that makes use of a generally transparent platen is now described in connection with FIGS. 2 and 3.

At step 310, an operator identifies a first sample to be scanned. The sample is identified by inputting to a computer 220 either a product number or name. Data input can be by way of a keyboard 222, touch-sensitive display screen 224, or other, conventional input device (e.g., a mouse or speech processing software). A presently preferred input device is a touch screen. The user interface is described below. The computer 220 communicates through ports or a data bus associated with the hardware 120 of the vision machinery 100 to supply the hardware 120 with a product definition to use. This product definition then governs the way in which captured image data is processed by the hardware 120.

Product definitions are conventional and form no part of the present invention. Typically, a product definition characterizes “features” that are specific to a sample's construction such as inner and outer diameters at various locations on the object, fluting, and the lengths, angles and arcs at such locations. There is a product definition for each of the samples that is to be inspected, and the product definition corresponding to a given sample is used in determining the measurement data to output.

Optionally, a data store 230 maintains an arbitrary number of product definition files that can be supplied by the computer to the vision machinery hardware 120, as well as other data that permits users to generate histograms, trend analyses, and other statistical information on the samples that they inspect.

At step 320, the camera can be repositioned, if required, to ensure that the selected product will fit within the field of view 250. Information associated with the product definition for the identified sample can prescribe a distance for the camera from the platen surface 212 and a lens and its settings to ensure that the sample is within the field of view. The present settings are compared to this information to determine if any adjustment is required. The adjustment, if any, can be displayed to the user for manual action, or can be implemented automatically by energizing a servo-motor or the like to translate the camera 110 along the Z axis.

At step 330, the user can be guided so as to better ensure that the sample is correctly placed (positioned and oriented) on the platen 210. Preferably, the system 200 includes indicators 240A and 240B, which are positioned along orthogonal margins of the platen 210 to indicate the correct position and orientation of the sample or a particular feature of the sample relative to the platen surface 212. The system 200 preferably associates a location on the platen 210 at which the identified sample or feature is to be placed, for example, together with the product definition. The location can be in coordinates or otherwise. In addition, the system 200 preferably associates an orientation of the sample or a feature thereof relative to the platen. After the sample is identified at step 310 and prior to image capture, the indicators 240A and 240B can be slidingly positioned alongside the platen (in tracks 242A and 242B) by energizing a motor using a signal provided by the computer 220 to indicate the correct placement of the sample on the platen 210. The indicators can be lasers which present crossing beams to signify the target location for a feature on the sample that is to be imaged, can be a mechanical element that is positioned to guide the user (a pointer, rod or other physical element) or a grid can be presented on or within the transparent plate (e.g., at a non-visible frequency such as infrared) to aid in the placement of the object. The indicators can also indicate an angular orientation for the sample or a feature on the sample (e.g., by rotating the beam or grid with additional servomotors or otherwise), or correct orientation can be depicted on a display of the computer 220.

The user places a sample on the platen surface 212, at step 340, along the axis of the camera lens 112 and on the opposite side of the platen 210 than the camera. At step 350, image data relating to the first sample is captured through the platen. The image data is a matrix of pixels of varying color (or grayscale) of any object and background that is in the camera's field of view. At step 360, the captured image data is output to the hardware 120 of the vision machinery 100. Typically, the background is a panel 260 which is selected to contrast with the color of the sample, e.g. a black panel is used if the sample is white, and in the arrangement of the preferred embodiment the sample is seated on the platen and spaced from the background panel 260. At step 370, the hardware 120 processes the output image data using the product definition for the identified sample (which was downloaded to the hardware 120 by the computer 220, if not already present) to derive measurement data (MD) for that sample.

As noted above, according to one aspect of the present invention, samples of different sizes can be inspected without the need to move the camera 110. This is enabled by positioning the camera on one side of a generally transparent platen and the samples on the other side because the leading edge of a sample is always at the same distance from the camera. This permits rapid exchanges of sample type without disrupting an existing system setup. The user interface, however, provides further benefits in that the user can be guided to correctly place a variety of different objects in the camera's field of view.

In accordance with a further aspect of the present invention, the MD information output by the hardware 120 is processed at step 380 to provide the user with greater understanding of any deviations from the product definition. Variances from a product definition can be a result of a number of factors including, but not limited to, wear of extrusion dies or molding molds, material variation, process variation and the like. By monitoring sample-to-sample changes, variation can be identified as a trend in the sample-to-sample data that otherwise could go undetected for many manufacturing cycles. Accordingly, the MD is processed at step 380 to provide a plot of any dimensional or rotational variation in one or more of the sample's features. The plot can illustrate conformance to or deviation from standard product specifications. Through the use of histograms and other statistical methods, based upon sample-to-sample variation, conformance to standards such as ISO 900X and /or QS9000 can then be demonstrated. The plot can be displayed on the display connected to the computer 220, and all of this data can be viewed at another machine that has access to the computer 220 through a network. Further, reports can be generated in which sample-to-sample changes are analyzed over predetermined periods. In this regard, a plurality of samples can be placed on the platen over a period of time (days, weeks, etc.) or in direct succession to one another, their respective images captured through the platen, and MD information derived at step 370 and processed at step 380. Even if samples corresponding to different product definitions are inspected at the same system 200, each of the samples corresponding to a given product definition will be inspected with the camera at the distance prescribed for that product.

At step 390, the computer stores the MD along with information concerning when that measurement data was obtained. The process flow then ends, but can be restarted by identifying a next sample, at step 310.

With reference now to FIGS. 4-10, an exemplary user interface for the system 200 is described. FIG. 4 illustrates a part entry form 400 that enables a user to identify the sample to be inspected by part number or name. The form provides a touch-sensitive interface with which the user interacts to enter alphanumeric characters. The product number or name is displayed in field 410. In addition to standard keys for alphanumeric data entry and editing, a key is provided to guide the user to the input form, described next.

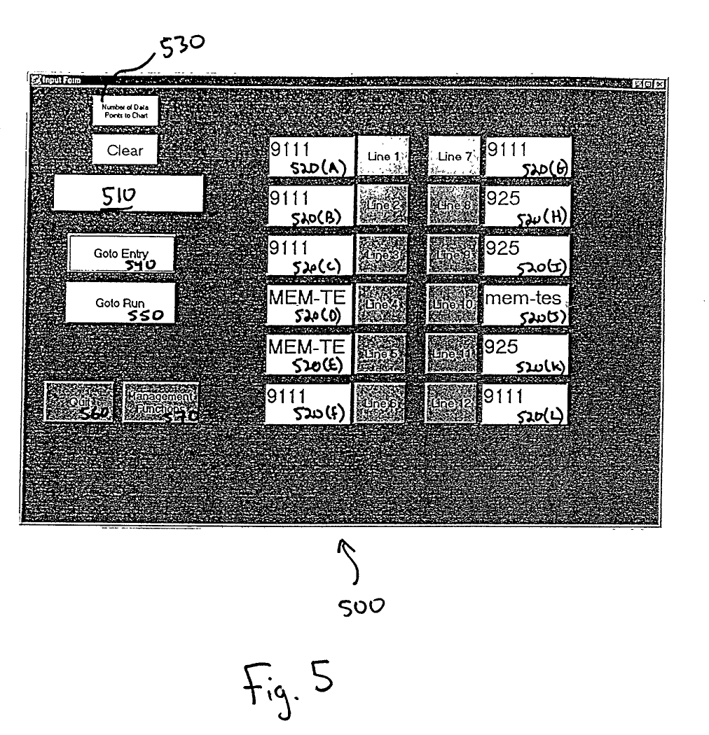

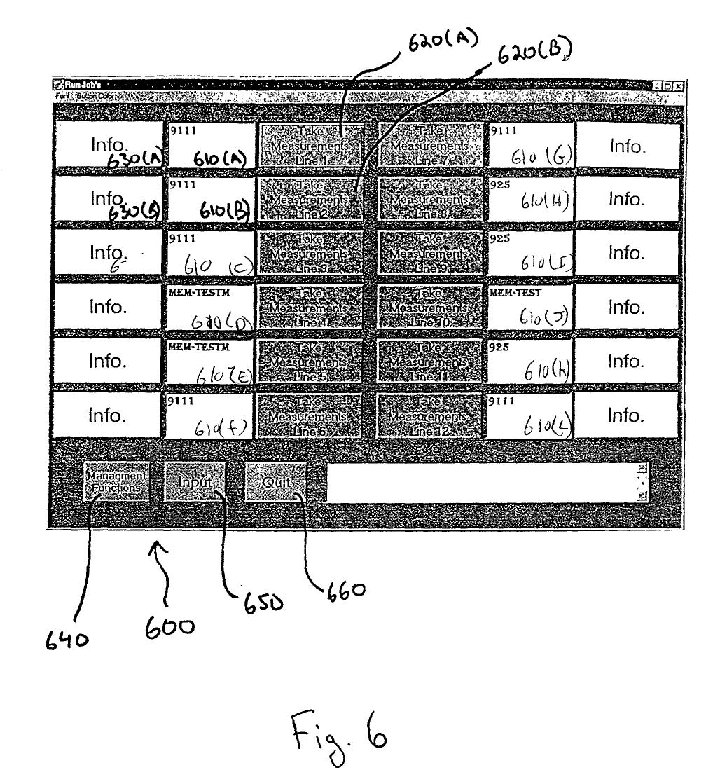

FIG. 5 shows an input form that is used to upload product definitions to the vision machinery 100. Once a sample has been identified using the alphanumeric characters on the part entry form, the data from field 410 is populated in field 510 of the input form. The user selects a line (slot) of the hardware 120 (associated with the vision machinery 100) into which the product definition is uploaded (using buttons 520(A) through 520(L), more generally referred to as “buttons 520”). Twelve lines are identified in FIG. 5, though fewer or a greater number of lines can be provided. The input form allows the user to select a product to test, and also permits the user to set the number of data points to include in a measurement data chart (e.g., from 0-25, a presently preferred range), for example, by pressing a button 530 and then entering a value. The input form also provides navigation buttons 540-570 to call up further displays and forms included with the user interface.

It should be understood that the forms of FIGS. 4 and 5 can be provided together on a single display if the display has sufficient real estate for the user to see and enter the requested information. In the touch-screen embodiment, separate forms have been found to better accommodate the user's fingers for reliable data entry.

Upon selecting a line using one of the buttons 520, a job execution form 600 is displayed. The job execution form launches the sample inspection process and permits the user to commence measurements from this single screen for any of the product definitions that have been loaded into the hardware 120. In particular, fields 610(A) through 610(L) identify the part number or name that has been loaded into the hardware 120, and corresponding buttons 620(A) through 620(L), when pressed, cause a measurement to be taken. Respective buttons 630(A) through 630(L) provide further information to the user concerning how the sample is to be positioned and oriented, and can be used to trigger the indicators 240 and/or any position mechanism 242 associated with the indicators and/or any other device or display responsive to the product selection/measurement buttons for indicting position and orientation. Navigation buttons 640-660 are also provided to guide the user to other forms and displays.

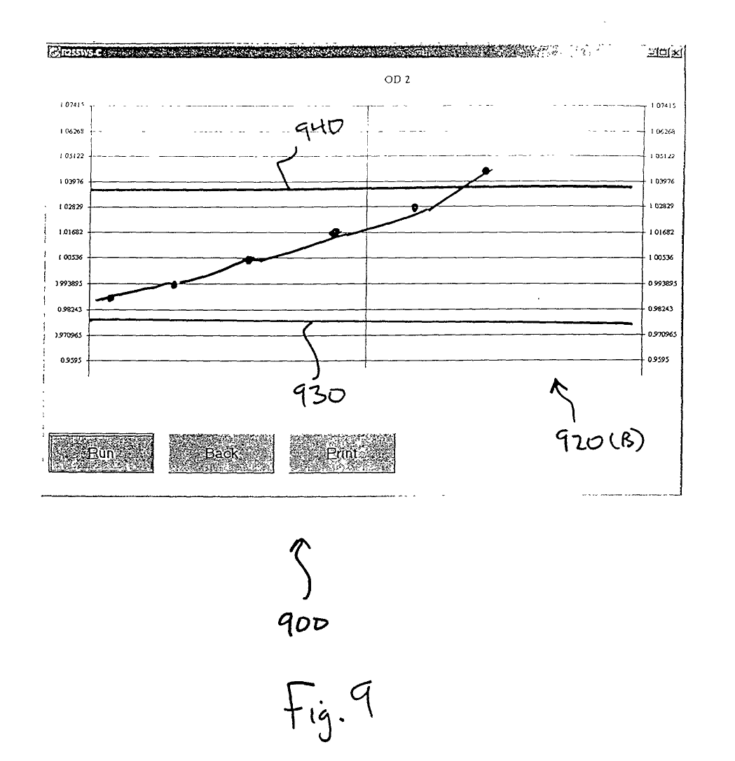

Thus, when a given button 620 is pressed, steps 310-390 described above in connection with FIG. 3 are performed. In particular, a test is made to determine if the computer 220 and the hardware 120 are properly communicating with one another, and, if not, an error message is provided to the user. Otherwise, the sample is identified (step 310) by virtue of selecting a specific one of the buttons 620(A) through 620(L). Optionally, the camera is translated along the Z axis (step 320), if necessary, to achieve a value setting or any criteria that may have been entered into the product definition or associated with the product definition. Also, the indicators 240, their position mechanism, if any, and any further guidance mechanisms are energized to guide the user in placing the sample on the platen in its proper location and orientation (step 330). With the sample suitably placed (step 340), an image is captured (350) by the camera 110 and output to the hardware 120 (step 360). The hardware 120 uses the product definition loaded into the activated slot to process the image data and generate measurement data. The measurement data is typically placed in a spreadsheet or the like for review by the user (step 370). In the preferred embodiment, however, the computer 220 detects the presence of the measurement data and ports it automatically from the hardware 120 for further processing (step 380), described below in connection with FIG. 8.

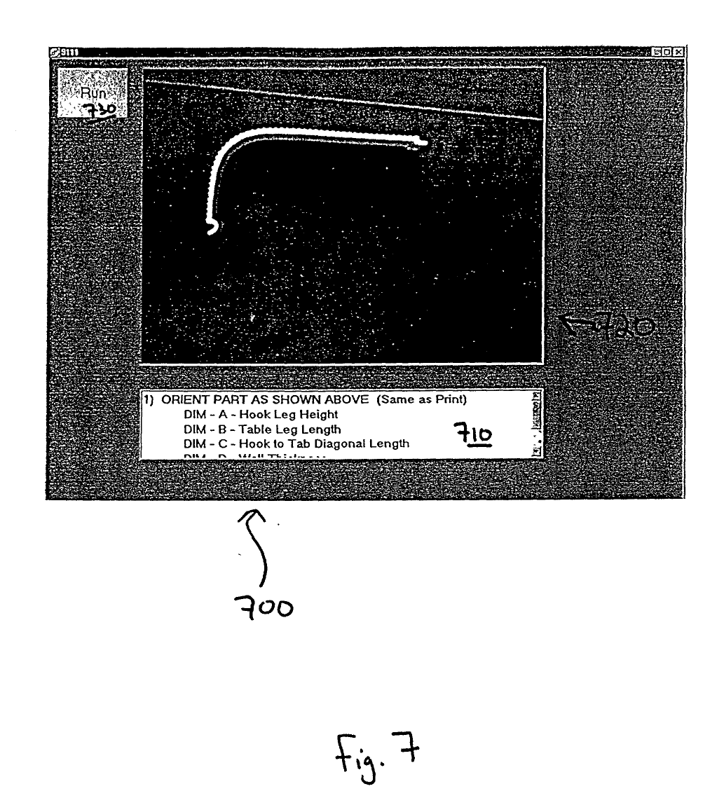

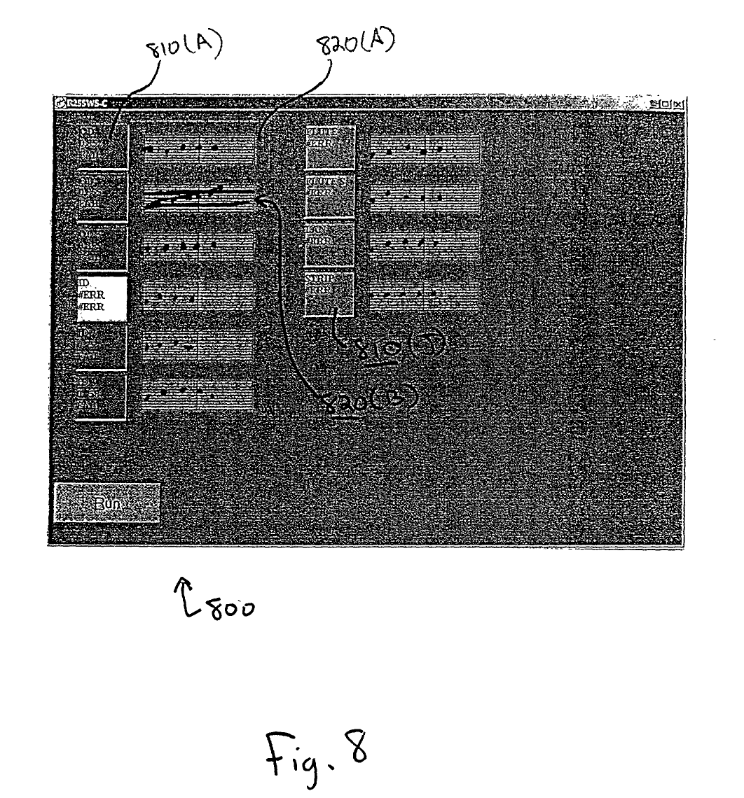

With brief reference to FIG. 7, an information form is shown that can be included in the user interface to provide information to the user concerning the product definitions that have been loaded into the hardware 120. The information buttons 630 call up particular information forms and can advise the user in a text box 710 how to position and orient the part on the platen 210, the correct position of the camera, the lens selection (e.g., wide angle or macro), its f-stop setting and focal length, information concerning any special considerations concerning that part, and can provide a picture of the part and other information in another portion 720 of the form. A navigation button 730 permits the user to return to the job execution form 600.

With reference now to FIGS. 6, 8 and 9, if in response to taking the measurement there are no errors in the measurement data, then the computer 220 constructs a data point (time taken, feature in question, and its measured value) that is included in a record for that product definition. The result of the measurement is shown on the output form 800 of FIG. 8. The output form displays measurement data (“MD”) for a plurality of features associated with a selected product definition together with thumbnail images of acquired MD. For each feature, there is a button 810 labeled with the feature that was measured (e.g., OD or OD2 for two different outside diameter measurements), the value from the measurement, and whether the product definition criteria was met (“PASS”), not met (“FAIL”), or whether there was an error during the measurement (“ERR”). The buttons 810 are preferably color coded to indicate the status of the testing such as green for PASS, red for FAIL, and yellow for ERR. The error indication can be numerically coded or otherwise associated with a specific error to guide the user in correcting the problem. In addition, there is preferably a thumbnail image 820 for each feature that preferably illustrates a graph of a prescribed number of data points that have been gathered (set using the button 520 on the input form 500). The thumbnail images 820 can show the data points themselves or with an interconnecting line, and can further show measurement thresholds (e.g., upper and lower boundaries) that must be satisfied for the sample to PASS. The buttons 510, when pressed, provide the user with an enlarged view of the acquired MD in a separate display. A navigation button 830 brings the user back to the job execution form 600.

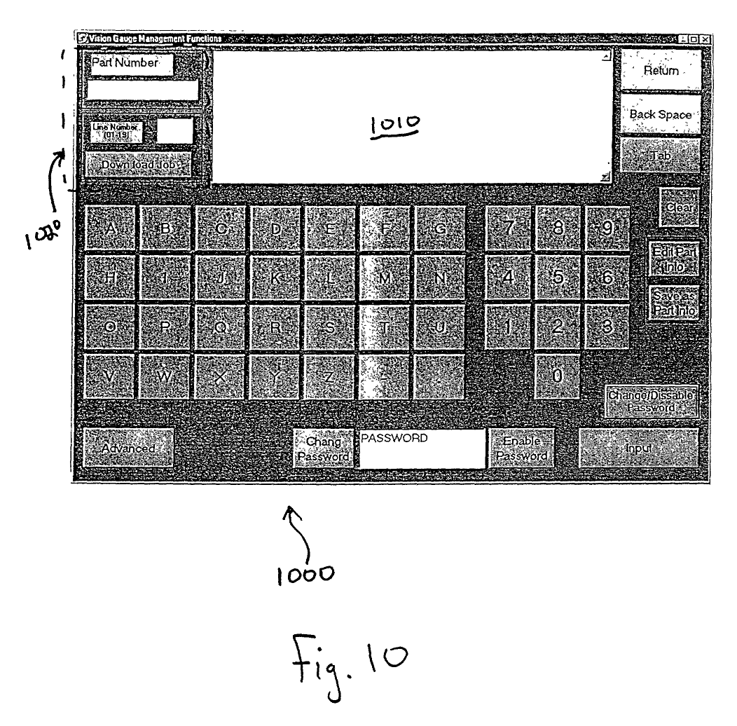

FIG. 9 is an enlarged view of the thumbnail image 820(B), showing sample-to-sample data points that have been gathered with regard to one feature of that product. As can be seen more clearly in FIG. 9, a series of data points have been gathered for a number of samples, all of which except for the last data point are within prescribed bounded limits 930, 940. The last point is a FAIL (see button 810(B)) because its value is out of range. The prior data points all measured as PASS because their values were within range. Importantly, however, the image 920(B) displays to the user the manufacturing variations and trends that led up to the failure of that feature, better enabling the user to implement changes in the manufacturing process (e.g., fine tuning of the mold or cleaning of the machinery) to place that feature within specification. Preferably, the vertical scale is automatically adjusted to a percentage above and below any boundaries input by the user, or with regard to the values of the MD received. There are navigation buttons on this display page as well, to guide the user to other forms and displays that are included in the user interface.

If the data measured in response to the measurement button 620 had resulted in an error, then the data point is not included in the record (that is, it is automatically discarded) and the user is advised accordingly. In that case, there would be no entry in the database for any of the features, even if the other features measured without an error.

FIG. 10 illustrates a management form 1000 that can be provided to assist the user in downloading, writing and editing product definitions for the vision machinery 100 an in writing information to include in the information form of FIG. 7. The management form 1000 includes an alphanumeric entry and editing buttons for entering and editing text that is displayable in a text box 1010, an entry form 1020 for entering a part number/name and a line from which to download a product definition from the hardware 120, password enable/disable and change capabilities, as well as navigation buttons. These components operate to create or modify data within the text box 1010 until it is saved.

Conventional cameras 110 can capture 640×480 picture elements (“pixel”) or more across their respective fields of view 150. The target feature of a sample that is being inspected will be within the resolution of the camera if the software can resolve the structure. Typically, software can resolve structures as small as approximately 0.25 pixel.

Many parts that are to be inspected lack symmetry and therefore the irregular shape may present the user with a non-intuitive center point to be located generally about the Z axis. However, the guidance system included with the present invention enables relatively unskilled users to correctly align the visual center of a sample part on the platen. The guidance system thus provides a benefit first during calibration when the product definition for that part is taken because it better ensures reproducibility when the same sample or a later manufactured part is placed on the platen for inspection. In particular, because the user is guided in the placement and orientation of the part, any spherical aberration effect will be accounted for in the product definition and subsequent inspections will be based on very similar part placements and so any spherical aberration effects at those subsequent inspections will be approximately the same. It should be appreciated that a different placement on the platen can result in a different gauging due solely to the difference in spherical aberration at that different placement. Consequently, there could be a false rejection of a part that otherwise would have passed inspection if placed properly.

Thus, a method is provided to utilize viewing direction of a machine vision camera through a transparent plate. Any object placed on the opposite side of the plate will have its viewed surface the same distance from the camera as any other object. This method lends itself to an upward viewing direction (as referenced from the camera), so that objects can be set onto a horizontal plane, but any orientation is possible if a method of holding the part against the transparent plate is devised. Further, a method is also provided to combine distance measuring devices and machine automation to first measure the distance from the machine vision camera to the viewed object (through free space, not through a transparent plate), and then to automatically adjust the distance between the camera and the viewed object in order to maintain a predetermined image scale.

While the invention has been described in detail with particular reference to an embodiment thereof, the invention is capable of other and different embodiments, and its details are capable of modifications in various obvious respects. As would be readily apparent to those skilled in the art, variations and modifications can be affected while remaining within the spirit and scope of the invention. Accordingly, the foregoing disclosure, description, and drawing figures are for illustrative purposes only, and do not in any way limit the invention, which is defined only by the claims.

What is claimed is:

1. In a machine vision system including a camera that captures image data of a sample, a method for inspecting one of a plurality of different workpieces, comprising the steps of:
a) positioning the camera at a prescribed distance from a first side of a platen;
a) placing a first sample selected from among the plurality of workpieces on a second side of the platen within the field of view of the camera, the second side of the platen being opposite the first side of the platen and the platen being generally transparent;
c) capturing image data of the first sample through the platen; and
d) outputting information relating to dimensional characteristics of the first sample.

2. The method as in claim 1, wherein there is a product definition for each of the plurality of workpieces and wherein the output information is relative to the product definition corresponding to the first sample.

3. The method as in claim 2, including the additional step of processing the captured image data using the product definition corresponding to the first sample prior to the step of outputting information.

4. The method as in claim 3, including the additional steps of:
e) placing a second sample that corresponds to a different workpiece than the first sample and therefore has a different product definition;
f) capturing image data of the second sample through the platen; and
g) outputting information relating to the dimensional characteristics of the second sample.

5. The method as in claim 4, wherein steps e) through g) are performed with the camera at the prescribed distance.

6. The method as in claim 2, including the additional steps of repositioning the camera in accordance with data in the product definition for the first sample.

7. The method as in claim 6, wherein the camera is repositioned automatically.

8. The method as in claim 2, including the additional step of maintaining the product definitions in a data store.

9. The method as in claim 8, wherein the data store maintains data on the dimensional characteristics of any sample placed on the platen.

10. The method as in claim 1, including the additional step of indicating a position of one of the first sample and a feature of the first sample relative to the platen.

11. The method as in claim 10, wherein there is a product definition for each of the plurality of workpieces and wherein an orientation of one of the sample and the feature of the sample relative to the platen is associated with the product definition for the first sample.

12. The method as in claim 11, wherein a location of one of the sample and the feature of the sample relative to the platen is associated with the product definition for the first sample.

13. The method as in claim 10, wherein the indicating step comprises positioning one or more indicators prior to the step of capturing image data.

14. The method as in claim 13, wherein the one or more indicators are positioned by a motor in response to a signal from the machine vision system.

15. The method as in claim 14, wherein the one or more indicators are selected from the group of lasers and mechanical pointers.

16. The method as in claim 10, including the additional step of indicating an orientation of one of the first sample and the feature of the fist sample relative to the platen.

17. The method as in claim 16, wherein the orientation is indicated by one of depiction on a display connected to the machine vision system, rotation of a beam and rotation of a grid displayed on or within the platen.

18. The method as in claim 1, including the additional steps of:
(e) repeating steps (b) through (d) for a plurality of first samples, all corresponding to the same one of the plurality of workpieces;
(f) monitoring changes in the output information for the plurality of first samples; and
(g) plotting the output information to display dimensional or rotational variation in one or more features of the plurality of first samples.

19. The method as in claim 18, wherein the plot further includes an indication of a standard product specification whereby a trend in the output in data can be gauged.

20. The method as in claim 1, wherein the step of outputting information includes providing the output information to a machine which is connected to the machine vision system through a network.

21. A user interface for interacting with a machine vision system having a computer, an input device, and a display, comprising:
a first form for identifying a sample to be inspected;
a second form for selecting a product definition for use in measuring the sample; and
a button operatively configured to trigger an indicator that indicates a position and an orientation of the sample on the platen in accordance with the selected product definition.

22. The user interface as in claim 21, wherein the sample to be inspected is identified on the first form by one of a part number and a name.

23. The user interface as in claim 21, wherein the first and second forms are presented together on a single display.

24. The user interface as in claim 21, further comprising a third form for commencing a measurement of the sample.

25. The user interface as in claim 24, wherein the third form includes the button.

26. The user interface as in claim 25, wherein the indicator indicates the position and the orientation of the sample on the display.

27. The user interface as in claim 25, wherein the indicator is associated with the platen and indicates the position and the orientation of the sample on the platen.

28. The user interface as in claim 27, wherein the indicator is automatically positioned to guide the position and the orientation of the sample on the platen.

29. The user interface as in claim 21, further comprising an information form providing information concerning at least one of a correct camera position of the camera, a lens selection, an f-stop setting, and a focal length.

30. The user interface as in claim 24, further comprising an output form configured to display the measurement of the sample.

31. The user interface as in claim 30, wherein the output form displays one or more data points, each data point comprising a measured value and a time taken for a particular feature of the sample.

32. The user interface as in claim 31, wherein data points for plural features of the sample are displayed together on the output form.

33. The user interface as in claim 30, wherein the measurement of the sample on the output form displays whether criteria in the product definition were met.

34. The user interface as in claim 30, wherein the measurement of the sample on the output form displays whether there was an error in the measurement.

35. The user interface as in claim 31, wherein the data points for successive measurements are displayed on a graph.

36. The user interface as in claim 35, wherein the vertical side of the graph is adjusted relative to one of boundaries input by a user and values from the measurement.

37. In a machine vision system, a method for characterizing one of a plurality of workpieces comprising the steps of:
a) selecting a product definition of one of the plurality of workpieces;
b) placing a sample on a platen within the field of view of the machine vision system;
c) capturing image data of the sample;
d) processing the image data for comparison to the product definition;
e) comparing the processed image data for conformance to the product definition;
f) comparing the processed image data for conformance to historical data concerning prior samples; and
g) reporting to the user information concerning the results of the comparing steps.
